(19) United States
(12) Patent Application Publication
(10) Pub. No.: US 2012/0162819 A1
(43) Pub. Date: Jun. 28, 2012

(54) LATCH MECHANISM AND DISK DRIVE WITH THE SAME

(75) Inventor: Toshiaki ABE, Nishitama-gun (JP)

(73) Assignee: Kabushiki Kaisha Toshiba, Tokyo (JP)

(21) Appl. No.: 13/250,796

(22) Filed: Sep. 30, 2011

(30) Foreign Application Priority Data
Dec. 27, 2010 (JP) 2010-291305

(51) Int. Cl. G11B 17/03; G05G 5/06

(52) U.S. Cl. 360/99.06; 74/532

(57) ABSTRACT

According to one embodiment, a latch mechanism of a disk drive includes a latch member which includes a bearing pivotably mounted on a pivot set up in the disk drive, a main body separated from the bearing, and a bridge portion connecting the bearing and the main body. The bridge portion is less rigid than the main body.

### CROSS-REFERENCE TO RELATED APPLICATIONS

This application is based upon and claims the benefit of priority from prior Japanese Patent Application No. 2010-291305, filed Dec. 27, 2010, the entire contents of which are incorporated herein by reference.

### FIELD

Embodiments described herein relate generally to a latch mechanism of a carriage and a disk drive provided with the latch mechanism.

### BACKGROUND

A disk drive, such as a magnetic disk drive, generally comprises a magnetic disk, spindle motor, pivotable carriage (or actuator), voice coil motor (VCM), board unit, etc. The magnetic disk is arranged in a housing. The spindle motor supports and rotates the disk. The carriage supports a magnetic head, and the VCM serves to drive the carriage.

The magnetic disk drive constructed in this manner requires a function to prevent the carriage that supports the head from rotating and moving the head to a region above the magnetic disk in a non-operational state such that the disk is not rotating. Normally, the carriage has its centers of rotation and gravity coincident with each other and does not rotate even when it is subjected to a translational impact. If a rotational impact is applied, however, the carriage may rotate by inertia, thereby moving the head to the region above the disk. To overcome this, a proposed magnetic disk drive comprises a latch mechanism that can prevent rotation of the carriage despite the rotational impact thereon. If a rotational impact is applied to the magnetic disk drive in a non-operational state, the latch mechanism engages with the carriage to prevent its pivoting motion, thereby holding the carriage in a retracted position.

Latch mechanisms can be roughly classified into two types, inertial latches and single latches.

An inertial latch comprises two components, an inertial lever that serves as a starting point of the operation of the mechanism and a latch (latch component) that latches the carriage. If a rotational impact is applied, the inertial lever pivots to push and turn the latch, whereupon the latch is caught by a lug on the carriage. Thus, an unexpected loading action of the carriage is prevented.

On the other hand, a single latch does not have the lever function described above and is configured to be activated by its own moment of inertia or repulsive contact with the carriage. This single latch is constructed so that the operations of the two components of the inertial latch are implemented by a single component.

To achieve its basic function, the latch mechanism is configured so that the latch component never fails to move in a free state. If the disk drive is subjected to vibrational disturbance or the like, therefore, the latch component itself may start to rattle and act as disturbance of the disk drive, thereby degrading performance of the disk drive.

In the latch mechanism, the latch component is located free from a pivot in the disk drive, and a gap is defined between the pivot and latch component such that the latch component is freely rotatable. If the housing of the disk drive in which the pivot is arranged externally receives vibrational disturbance, the latch component rattles in the gap between itself and the pivot. The latch component has a moment of inertia as a parameter that determines its function. This inertial moment should be kept at a certain high value, which leads to an increase in the weight of the main body of the latch component. If the weight of the latch component increases, impact energy is inevitably transmitted to the housing when the latch component strikes the pivot. This impact energy is transmitted to the carriage of the disk drive and causes disturbance that adversely affects the positioning of the head.

The impact energy may be reduced by means of a soft resin that serves as a buffer material. Since the track pitch has recently been reduced with a remarkable increase in recording capacity, however, the existing energy buffering capacity has become insufficient.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view showing a hard disk drive (HDD) according to a first embodiment;

FIG. 2 is an enlarged plan view showing a part of the HDD;

FIG. 3 is an exploded perspective view showing a carriage and latch mechanism of the HDD;

FIG. 4 is a plan view showing a latch arm of the carriage mechanism;

FIG. 5 is a sectional view of the latch arm taken along line V-V of FIG. 4;

FIG. 6 is a sectional view of the latch arm taken along line VI-VI of FIG. 4;

FIG. 7 is a plan view showing the latch arm of the carriage mechanism;

FIG. 8 is a sectional view of the latch arm taken along line VIII-VIII of FIG. 7;

FIG. 9 is a sectional view of the latch arm taken along line IX-IX of FIG. 7;

FIG. 10 is a plan view showing an HDD according to a second embodiment;

FIG. 11 is an exploded perspective view showing a carriage and latch mechanism of the HDD;

FIG. 12 is a plan view showing a latch arm of the HDD; and

FIG. 13 is a sectional view of the latch arm taken along line XIII-XIII of FIG. 12.

### DETAILED DESCRIPTION

Various embodiments will be described hereinafter with reference to the accompanying drawings.

In general, according to one embodiment, a latch member includes a bearing pivotably mounted on a pivot set up in the disk drive, a main body separated from the bearing, and a bridge portion connecting the bearing and the main body. The bridge portion is less rigid than the main body.

Disk drives according to embodiments will now be described in detail.

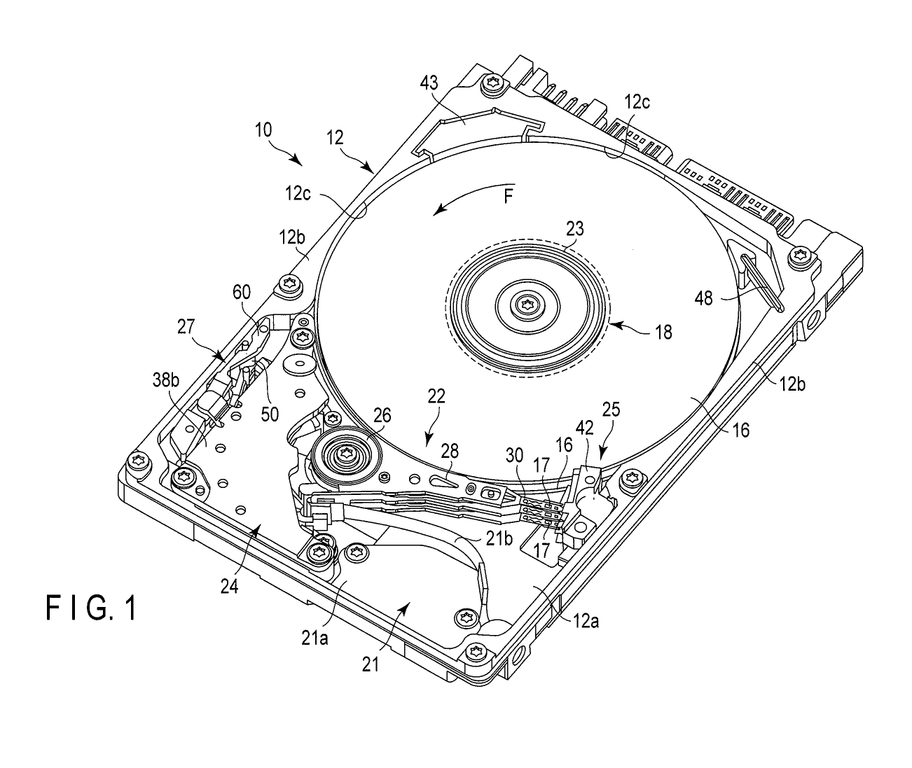

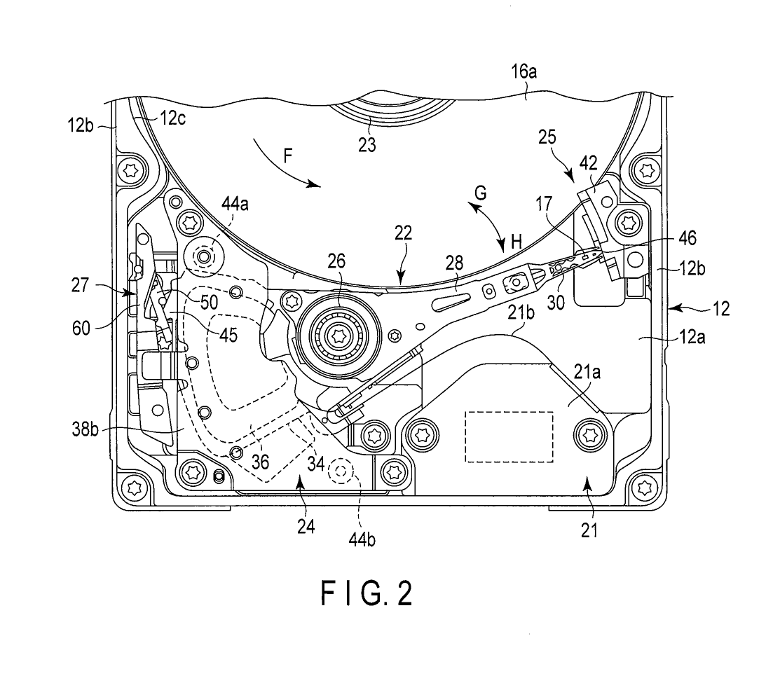

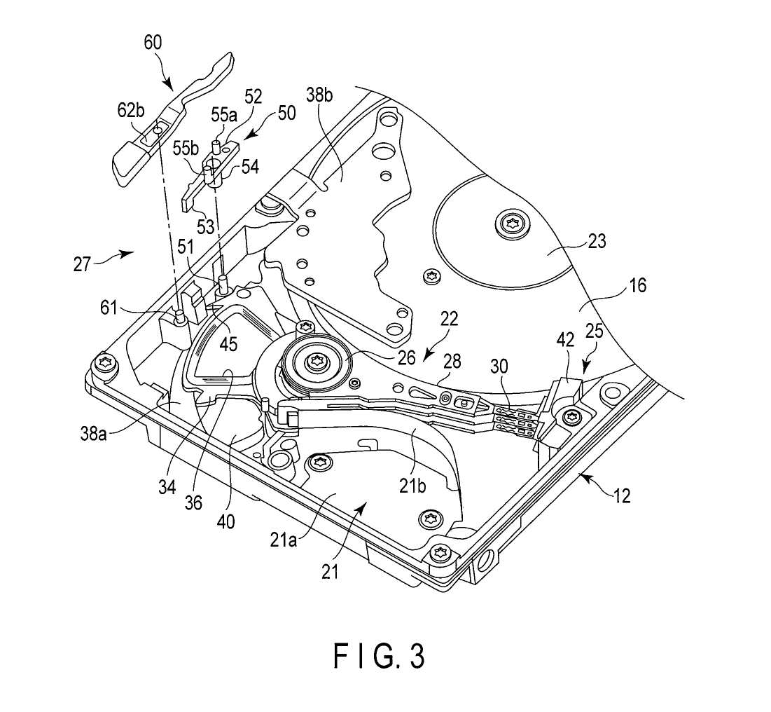

FIG. 1 shows the internal structure of an HDD according to a first embodiment with its top cover removed, FIG. 2 shows a carriage and latch mechanism section of the HDD, and FIG. 3 is an exploded perspective view showing the carriage and latch mechanism of the HDD.

As shown in FIG. 1, the HDD comprises a housing 10. The housing 10 comprises a base 12 in the form of an open-topped rectangular box and a top cover (not shown), which is attached to the base by screws such that it closes the top opening of the base. The base 12 for use as a platform comprises a rectangular bottom wall 12a and sidewall 12b set up along the peripheral edge of the bottom wall.

The housing 10 contains a spindle motor 18 and a plurality of magnetic disks 16. The spindle motor 18 for use as a drive unit is mounted on the bottom wall 12a of the base 12. The disks 16 are supported and rotated by the spindle motor. Further, the housing 10 contains a plurality of magnetic heads 17, carriage (or actuator) 22, voice coil motor (VCM) 24, ramp loading mechanism 25, latch mechanism 27, and board unit 21. The magnetic heads 17 record data on and reproduce data from the magnetic disks 16. The carriage 22 supports the heads 17 for movement relative to the disks 16. The VCM 24 pivots and positions the carriage. The ramp loading mechanism 25 holds the magnetic heads in a retracted position off the magnetic disks when the heads are moved to the outermost peripheries of the disks. The latch mechanism 27 holds the carriage in its retracted position if the HDD is externally jolted, for example. The board unit 21 comprises a preamplifier and the like.

A printed circuit board (not shown) is attached to the outer surface of the bottom wall 12a of the base 12 by screws. The circuit board controls the operations of the spindle motor 18, VCM 24, and magnetic heads 17 through the board unit 21. The base 12 is provided with a circulatory filter 48 and breather filter 43. The circulatory filter 48 serves to remove dust in the housing 10. The breather filter 43 traps dust from the external air introduced into the housing 10.

Each magnetic disk 16 for use as a recording medium is formed with a diameter of, for example, 65 mm (2.5 inches) and comprises magnetic recording layers on its upper and lower surfaces, individually. The disks 16 are coaxially mounted on a hub (not shown) of the spindle motor 18 and clamped and secured to the hub by a clamp spring 23. Thus, the disks 16 are supported parallel to the bottom wall 12a of the base 12. The disks 16 are rotated in the direction of arrow F at a predetermined speed of, for example, 5,400 or 7,200 rpm by the spindle motor 18.

That part of the sidewall 12b which is located in substantially half the area of the base 12 with respect to its longitudinal direction surrounds the outer peripheral edges of the magnetic disks 16. The sidewall 12b comprises a facing surface 12c that stands substantially upright from the bottom wall 12a. The facing surface 12c continuously extends in a circular arc along and opposite the outer peripheral edges of the disks 16 with a small gap therebetween. Thus, the sidewall 12b comprising the facing surface 12c constitutes a shroud for the disks 16.

As shown in FIGS. 1 to 3, the carriage 22 comprises a bearing 26 secured to the bottom wall 12a of the base 12 and four arms 28 extending from the bearing. The bearing 26 is spaced apart from the center of rotation of the magnetic disks 16, longitudinally relative to the base 12, and is located near the outer peripheral edges of the disks 16. The arms 28 are arranged parallel to the surfaces of the disks 16 and at predetermined spaces from one another and extend in the same direction from the bearing 26. The carriage 22 comprises elastically deformable suspensions 30 each in the form of an elongated plate. Each suspension 30 is formed of a plate spring, the proximal end of which is secured to the distal end of its corresponding arm 28 by spot welding or crimping. Alternatively, each suspension 30 may be formed integrally with its corresponding arm 28.

Each magnetic head 17 is mounted on an extended end of its corresponding suspension 30. Each head 17 comprises a substantially rectangular slider and magnetoresistive (MR) recording and reproduction heads formed on the slider and is secured to a gimbal portion on the distal end portion of the suspension 30. Each two of the plurality of heads 17 mounted individually on the suspensions 30 are opposed to each other so that each corresponding magnetic disk 16 is sandwiched between them.

On the other hand, the carriage 22 comprises a support frame 34 extending from the bearing 26 so as to be directed opposite from the arms 28. The support frame 34 supports a voice coil 36 that constitutes a part of the VCM 24. The VCM 24, which functions as a drive section, comprises a lower yoke 38a, upper yoke 38b, and magnets 40, which are all plate-like. The lower yoke 38a is located on the bottom wall 12a of the base 12. The upper yoke 38b is opposed to the lower yoke with a gap therebetween and located on the top-opening side of the base 12. The magnets 40 are secured individually to the respective inner surfaces of the lower and upper yokes and opposed to each other with a gap therebetween. The voice coil 36 mounted on the carriage 22 is located between the two magnets 40.

If the voice coil 36 is energized, the carriage 22 is pivoted about the bearing 26 between the retracted position where the magnetic heads 17 are located off the magnetic disks 16 on the outer peripheral side thereof and a data processing position where the heads 17 are located on the disks. Specifically, as shown in FIG. 2, the carriage 22 is pivoted in the direction of arrow G (loading direction) and direction of arrow H (unloading direction) about the bearing 26. Thereupon, the magnetic heads 17 are moved to and positioned in regions above desired tracks of their corresponding magnetic disks 16. Thus, the heads 17 can write data to or read data from the disks 16. The carriage 22 and VCM 24 constitute a head actuator. When the HDD is operating, the magnetic disks 16 are rotated at high speed by the spindle motor 18. Thereupon, each magnetic head 17 is kept flying relative to a surface of its corresponding disk by the airflow that is produced between itself and the disk surface.

First and second securing stops 44a and 44b, each in the form of a pin, are set up between the lower and upper yokes 38a and 38b. The first securing stop 44a is arranged in a position where it is struck by the support frame 34 of the carriage 22 when the carriage is pivoted to the retracted position. Thus, the first securing stop 44a keeps the carriage 22 from excessively moving toward the retracted position, that is, in the unloading direction H. The second securing stop 44b is arranged in a position where it is struck by the support frame 34 when the carriage 22 is pivoted to the innermost peripheral side of the magnetic disks 16. Thus, the second securing stop 44b keeps the carriage 22 from excessively moving toward the data processing position, that is, in the loading direction G. The first and second securing stops 44a and 44b are made elastic in order to absorb an impact when they contact the support frame 34. For example, the respective surfaces of the first and second securing stops 44a and 44b are covered by an elastic material, such as synthetic resin or rubber.

As shown in FIGS. 2 and 3, an outwardly projecting engaging pawl 45 is integrally formed on the support frame 34 of the carriage 22. The engaging pawl 45 constitutes an engaging portion of the latch mechanism 27.

As shown in FIGS. 1 and 2, the ramp loading mechanism 25 comprises a ramp 42, provided on the bottom wall 12a of the base 12 and located outside the magnetic disks 16, and tabs 46 extending individually from the respective distal ends of the suspensions 30. The ramp 42 is located downstream of the bearing 26 with respect to the direction of rotation F of the disks 16. When the carriage 22 pivots so that the magnetic heads 17 are pivoted to the retracted position outside the disks 16, each of the tabs 46 engages with a corresponding ramp surface formed on the ramp 42 and is impelled up the ramp to unload the heads 17.

The board unit 21 comprises a main body 21a, which is formed of a flexible printed circuit board and is secured to the bottom wall 12a of the base 12. Electronic components, including a head amplifier, are mounted on the body 21a. The board unit 21 comprises a main flexible printed circuit board (main FPC) 21b extending from the body 21a. An extended end of the main FPC 21b is connected to the vicinity of the bearing 26 of the carriage 22. Further, the extended end is electrically connected to the magnetic heads 17 by cables (not shown) on the arms 28 and suspensions 30. Connectors (not shown) for connection with the printed circuit board are mounted on the bottom surface of the main body of the board unit 21.

FIG. 3 is an exploded perspective view showing the latch mechanism 27. As shown in FIGS. 1 to 3, the latch mechanism 27 is arranged on the bottom wall 12a of the base 12. When the HDD is subjected to an external force, such as an impact, the latch mechanism 27 latches the carriage 22 in the retracted position, thereby preventing the carriage from moving from the retracted position to the data processing position.

The latch mechanism 27 is formed as, for example, an inertial latch mechanism, which comprises a latch arm 50, for use as a latch member, and an inertial arm 60. These arms 50 and 60 are pivotably supported on first and second pivots 51 and 61, respectively, set up on the bottom wall 12a of the base 12.

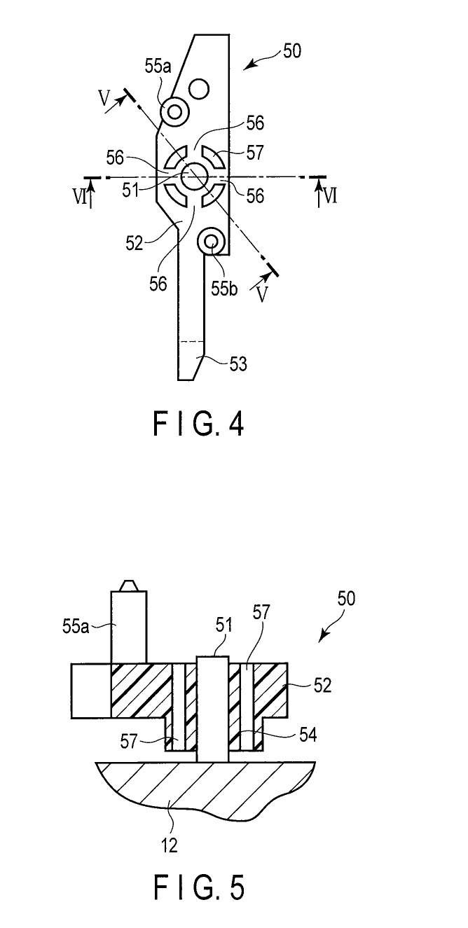

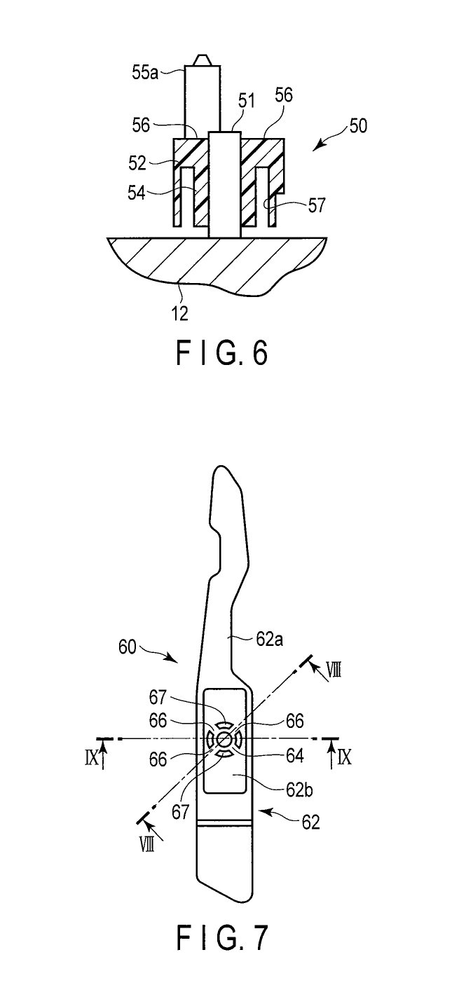

As shown in FIGS. 3 to 6, the latch arm 50 comprises a main body 52 in the form of an elongated arm and a cylindrical bearing 54 located substantially in the center of the main body 52. The latch arm 50 is pivotably supported on the first pivot 51 passed through the bearing 54. A latch pawl 53 capable of engaging with the engaging pawl 45 of the carriage 22 is formed on one end portion of the main body 52. First and second engaging pins 55a and 55b protrude from the main body 52 such that they extend parallel to the bearing 54 and are located on either side of the bearing 54.

In the latch arm 50, the main body 52 and bearing 54 are separated from each other and connected by bridge portions 56. Each bridge portion 56 is so narrow, elongated, and thin-walled that it is less rigid than the main body 52. More specifically, an annular slit 57 is formed in that part of the main body 52 which surrounds the bearing 54. The slit 57 divides the main body 52 from the bearing 54. The bridge portions 56, e.g., four, extend radially relative to the center of the bearing, that is, to the first pivot 51, and cross the slit 57 to connect the bearing 54 and main body 52. The four bridge portions 56 are arranged at regular intervals along the circumference of the bearing 54. According to the present embodiment, the main body 52, bearing 54, and bridge portions 56 are integrally molded from synthetic resin.

Alternatively, the bearing 54 and bridge portions 56 may be integrally molded from synthetic resin such that the separately formed main body 52 is connected to the bridge portions 56.

Thus, the slit 57 is formed in that part of the main body 52 which transmits energy to the bearing 54, and the main body 52 and bearing 54 are connected by the slender bridge portions 56. Even if the main body 52 is jolted, therefore, the amount of mass-based impact energy transmitted to the bearing 54 and first pivot 51 can be considerably reduced while maintaining rigidity to preserve the original shape of the main body.

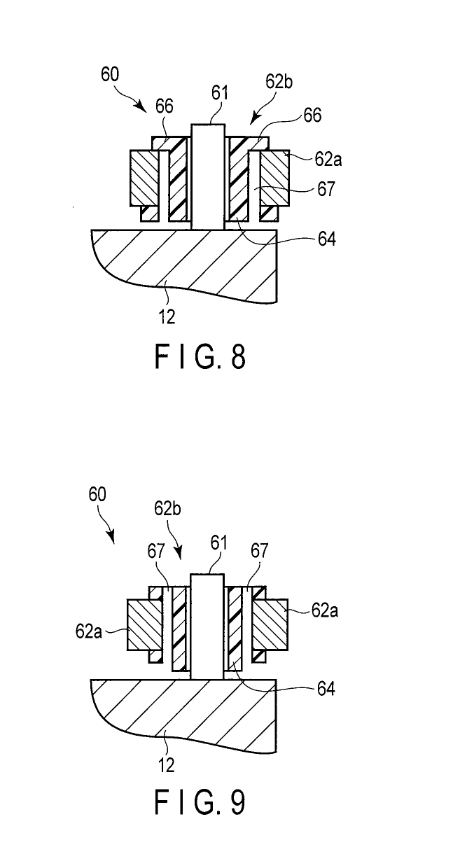

As shown in FIGS. 3, 7, 8 and 9, the inertial arm 60 comprises a main body 62 in the form of an elongated arm and a cylindrical bearing 64 located substantially in the center of the main body 62. The inertial arm 60 is pivotably supported on the second pivot 61 passed through the bearing 64.

The main body 62 comprises a major portion 62a, consisting mainly of, for example, a high-mass metal, and a rectangular central portion 62b of synthetic resin embedded in the central part of the major portion 62a.

In the central portion 62b, the main body 62 and bearing 64 are separated from each other and connected by bridge portions 66. Each bridge portion 66 is so narrow, elongated, and thin-walled that it is less rigid than the main body 62. More specifically, an annular slit 67 is formed in that part of the central portion 62b which surrounds the bearing 64. The slit 67 divides the main body 62 from the bearing 64. The bridge portions 66, e.g., four, extend radially relative to the center of the bearing 64, that is, to the second pivot 61, and cross the slit 67 to connect the bearing 64 and central portion 62b. The four bridge portions 66 are arranged at regular intervals along the circumference of the bearing 64. According to the present embodiment, the central portion 62b of the main body 62, bearing 64, and bridge portions 66 are integrally molded from synthetic resin.

Thus, the slit 67 is formed in that part of the main body 62 which transmits energy to the bearing 64, and the main body 62 and bearing 64 are connected by the slender bridge portions 66. Even if the main body 62 is jolted, therefore, the amount of mass-based impact energy transmitted to the bearing 64 and second pivot 61 can be considerably reduced while maintaining rigidity to preserve the original shape of the main body.

As shown in FIGS. 2 and 3, an arm portion of the inertial arm 60 extends at right angles to the second pivot 61 and between the first and second engaging pins 55a and 55b of the latch arm 50. Side edges of the arm portion engage with the first and second engaging pins 55a and 55b, individually.

During normal operation of the HDD, the latch arm 50 of the latch mechanism 27 is held in its release position. In the release position, the latch pawl 53 of the latch arm 50 is separated from the engaging pawl 45 of the carriage 22, thereby allowing the carriage to pivot. If the HDD is subjected to an external force with the carriage 22 in the retracted position or to a counterclockwise rotational impact about the bearing 26 of the carriage 22, for example, the inertial arm 60 pivots counterclockwise about the second pivot 61. Thereupon, the arm portion of the inertial arm 60 presses the first engaging pin 55a of the latch arm 50, thereby pivoting the latch arm counterclockwise about the first pivot 51. In this way, the latch arm 50 moves to a latch position, whereupon the latch pawl 53 engages with the engaging pawl 45 of the carriage 22, thereby latching the carriage. Thus, the carriage 22 is kept from pivoting and held in the retracted position by the latch pawl 53.

If the HDD is subjected to an external force with the carriage 22 in the retracted position or to a clockwise rotational impact about the bearing 26 of the carriage 22, for example, the inertial arm 60 pivots clockwise about the second pivot 61. Thereupon, the arm portion of the inertial arm 60 presses the second engaging pin 55b of the latch arm 50, thereby pivoting the latch arm counterclockwise about the first pivot 51. In this way, the latch arm 50 moves to the latch position, whereupon the latch pawl 53 engages with the engaging pawl 45 of the carriage 22, thereby latching the carriage. Thus, the carriage 22 is kept from pivoting and held in the retracted position by the latch arm 50.

According to the latch mechanism constructed in this manner and the HDD provided with the same, the latch member has a framework (joint) structure such that its main body is separated from and connected to the bearing that supports the pivot on the base, whereby the transmission portion can be made less rigid. Thus, even if the latch member is jolted, it can reduce the amount of mass-based impact energy transmitted to the pivot while maintaining rigidity to preserve its original shape. Even a mechanical component having a moment of inertia (weight) at the same level as conventional ones can reduce the amount of disturbance energy applied to the HDD. Thus, there may be obtained a latch mechanism and an HDD, capable of maintaining basic configurations and latch function such that the positioning accuracy of the head cannot be easily affected by disturbance due to the presence of the latch mechanism.

The following is a description of an HDD according to a second embodiment.

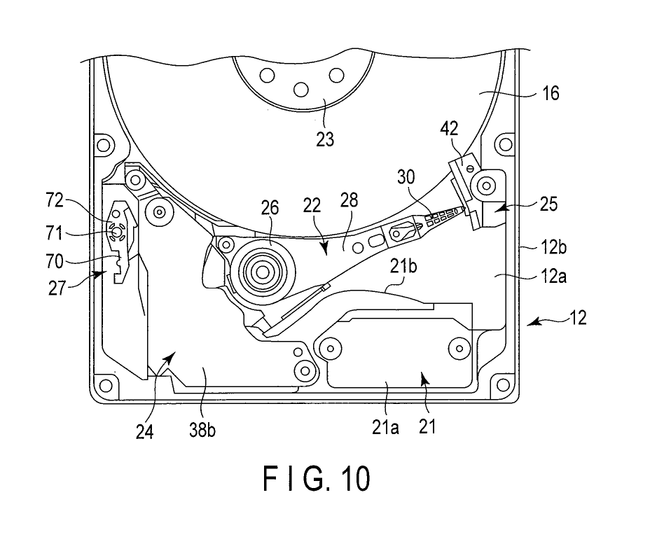

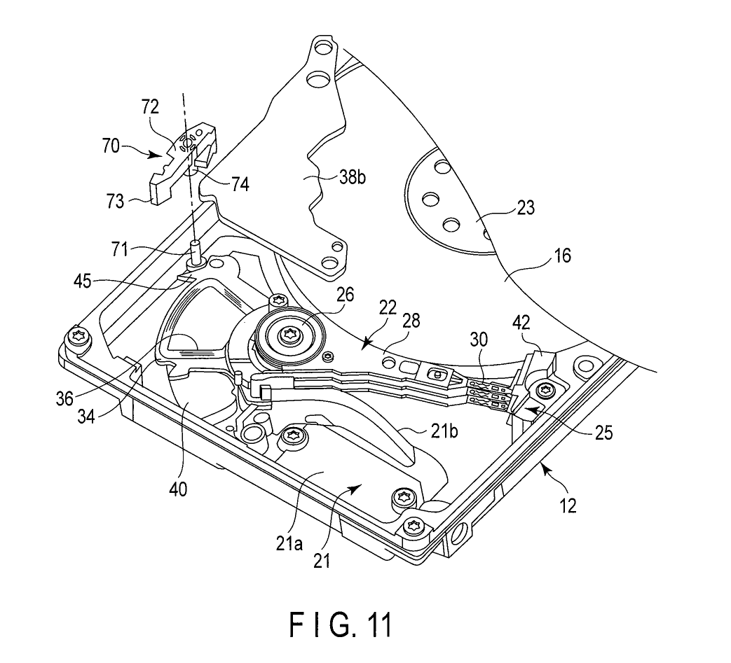

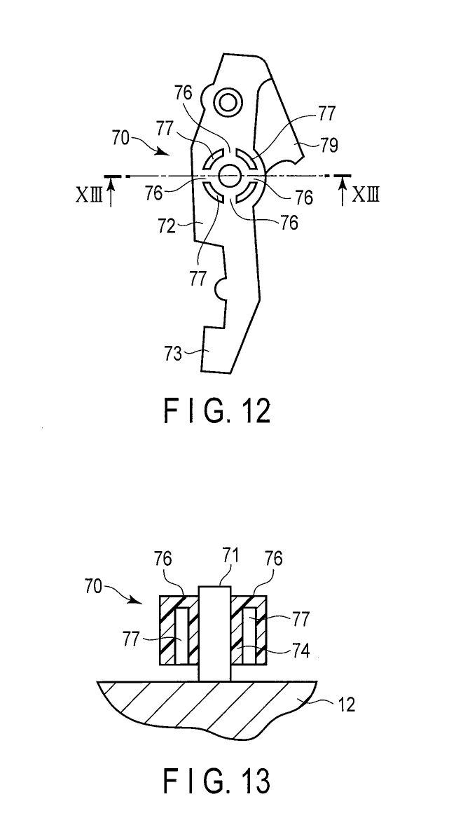

FIGS. 10 and 11 show a carriage and latch mechanism of the HDD of the second embodiment, and FIGS. 12 and 13 show a latch member of the latch mechanism.

According to the second embodiment, as shown in FIGS. 10 and 11, a latch mechanism 27 of the HDD is formed as a single latch, which serves to latch a carriage 22 in a retracted position, thereby preventing the carriage from moving from the retracted position to a data processing position, when the HDD is subjected to an external force, such as an impact.

As shown in FIGS. 10 to 13, the latch mechanism 27 comprises a latch arm 70 for use as a latch member. The latch arm 70 is pivotably supported on a pivot 71 set up on a bottom wall 12a of a base 12.

As shown in FIGS. 10 to 13, the latch arm 70 comprises a main body 72 in the form of an elongated arm and a cylindrical bearing 74 located substantially in the center of the main body 72. The latch arm 70 is pivotably supported on the pivot 71 passed through the bearing 74. A latch pawl 73 capable of engaging with an engaging pawl 45 of the carriage 22 is formed on one end portion of the main body 72. An abutting portion 79 capable of abutting an end portion of the carriage 22 is formed on the other end portion of the main body 72.

In the latch arm 70, the main body 72 and bearing 74 are separated from each other and connected by bridge portions 76. Each bridge portion 76 is so narrow, elongated, and thin-walled that it is less rigid than the main body 72. More specifically, an annular slit 77 is formed in that part of the main body 72 which surrounds the bearing 74. The slit 77 divides the main body 72 from the bearing 74. The bridge portions 76, e.g., four, extend radially relative to the center of the bearing, that is, to the pivot 71, and cross the slit 77 to connect the bearing 74 and main body 72. The four bridge portions 76 are arranged at regular intervals along the circumference of the bearing 74. According to the present embodiment, the main body 72, bearing 74, and bridge portions 76 are integrally molded from synthetic resin.

Alternatively, the bearing 74 and bridge portions 76 may be integrally molded from synthetic resin such that the separately formed main body 72 is connected to the bridge portions 76. Since other configurations of the HDD are the same as those of the first embodiment, like reference numbers are used to designate like portions, and a detailed description thereof is omitted.

According to the second embodiment, that part of the main body 72 of the latch member which transmits energy to the bearing 74 is thin-walled and formed with the slit 77, and the main body 72 and bearing 74 are connected by the slender bridge portions 76. Even if the main body 72 is jolted, therefore, the amount of mass-based impact energy transmitted to the bearing 74 and first pivot 71 can be considerably reduced while maintaining rigidity to preserve the original shape of the main body. Thus, there may be obtained a latch mechanism and an HDD, capable of maintaining basic configurations and latch function such that the positioning accuracy of the head cannot be easily affected by disturbance.

According to the first and second embodiments described in detail herein, there may be provided a latch mechanism with high reliability against impact, capable of sufficiently reducing impact energy by a disturbance input, and a disk drive provided with the same.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the shape of the latch member is not limited to the arm-like shape and may be variously changed. The number of bridge portions of the latch member is not limited to four and may be varied as required. The number of magnetic disks is not limited to two and may be varied as required. Further, the magnetic disks are available in any size, e.g., 3.5, 2.5, or 1.8 inches.

What is claimed is:

1. A latch mechanism configured to latch an actuator of a disk drive, comprising:
a latch member comprising a bearing pivotably mounted on a pivot set up in the disk drive, a main body separated from the bearing, and a bridge portion connecting the bearing and the main body,
the bridge portion being less rigid than the main body.

2. The latch mechanism of claim 1, wherein the latch member comprises an annular slit formed between the main body and a periphery of the bearing and a plurality of bridge portions extending radially relative to the bearing through the slit and connecting the bearing and the main body.

3. The latch mechanism of claim 2, wherein the bridge portion is formed mainly of synthetic resin.

4. The latch mechanism of claim 3, wherein the bearing and the bridge portion are integrally molded from synthetic resin.

5. The latch mechanism of claim 3, wherein the main body, the bearing, and the bridge portion are integrally molded from synthetic resin.

6. The latch mechanism of claim 1, wherein the bridge portion is formed mainly of synthetic resin.

7. The latch mechanism of claim 6, wherein the bearing and the bridge portion are integrally molded from synthetic resin.

8. The latch mechanism of claim 6, wherein the main body, the bearing, and the bridge portion are integrally molded from synthetic resin.

9. The latch mechanism of claim 1, wherein the main body comprises a central portion integrally molded from synthetic resin with the bearing and the bridge portion and a metallic major portion in which the central portion is embedded.

10. A disk drive comprising:
a housing storing a disk-shaped recording medium and a motor configured to rotate the recording medium;
a carriage rotatably provided in the housing and supporting a head configured to perform data processing on the recording medium; and
a latch mechanism configured to latch and hold the carriage in a retracted position when the carriage in the retracted position is subjected to an external force, wherein
the latch mechanism comprises a latch member comprising:
a bearing pivotably mounted on a pivot set up in the disk drive, a main body separated from the bearing, and a bridge portion connecting the bearing and the main body, the bridge portion being less rigid than the main body.

11. The disk drive of claim 10, wherein the latch member comprises an annular slit formed between the main body and the periphery of the bearing and a plurality of bridge portions extending radially relative to the bearing through the slit and connecting the bearing and the main body.

12. The disk drive of claim 11, wherein the bridge portion is formed mainly of synthetic resin.

13. The disk drive of claim 12, wherein the bearing and the bridge portion are integrally molded from synthetic resin.

14. The disk drive of claim 12, wherein the main body, the bearing, and the bridge portion are integrally molded from synthetic resin.

15. The disk drive of claim 10, wherein the bridge portion is formed mainly of synthetic resin.

16. The disk drive of claim 15, wherein the bearing and the bridge portion are integrally molded from synthetic resin.

17. The disk drive of claim 15, wherein the main body, the bearing, and the bridge portion are integrally molded from synthetic resin.

18. The disk drive of claim 10, wherein the main body comprises a central portion integrally molded from synthetic resin integrally with the bearing and the bridge portion and a metallic major portion in which the central portion is embedded.
